(19) United States
(12) Patent Application Publication
(10) Pub. No.: US 2007/0106408 A1
(43) Pub. Date: May 10, 2007

(54) Automatic design system, automatic design method, and automatic design program

(75) Inventors: Masaki Ikeda, Kanagawa (JP); Shin Okamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/580,312

(22) PCT Filed: Jan. 25, 2005
(86) PCT No.: PCT/JP05/01307

§ 371 Date: May 25, 2006

(30) Foreign Application Priority Data
Apr. 26, 2004 (JP) 2004-129990

(51) Int. Cl. G06F 19/00

(52) U.S. Cl. 700/97; 700/182

(57) ABSTRACT

An automatic design system, includes an automatic designing means 3 for computing output value information in compliance with output value computing information containing computational expressions, based on input value information required for automatic design of a product, a draughting information forming means 4 for forming draughting information to display the input value information, the output value information, and a drawing showing a shape based on the input value information and the output value information, an image displaying means 7 for displaying a drawing based on the draughting information, and an attribute changing means 6 for changing a display attribute on a drawing displayed by the image displaying means 7 such that a display mode of the input value information is made different distinguishably from display modes of other information.

### TECHNICAL FIELD

The present invention relates to an automatic design system, an automatic design method, and an automatic design program, which are used to make an automatic design by using a computer.

### BACKGROUND ART

In order to improve efficiency in the product design work in various manufacturers, an automatic design system using a computer have been developed in the prior art. A time required for a product design work and a draft making work can be reduced considerably by the automatic design system. In the case where a design is made by utilizing this automatic design system, first input value information, e.g., dimension values, and the like, which are required of the product as the object of automatic design (information of standard specifications) are input into the computer by an operator such as a designer, or the like (i.e., numerical values are input manually into the computer). Then, the computer makes (i.e., computes) an automatic design based on the input numerical values in compliance with output value computing information such as computational expression, computing procedures, design standards, and the like, which are previously recorded in a database, to form output value information. Then, the computer forms draughting information used to display the drawing, based on the output value information and the input value information. Then, the computer causes an image display device to output (i.e., display) a drawing containing figures (shapes), dimension values, etc. onto a display screen or a printing recording medium, based on the draughting information.

Further, a drawing checking work is applied to the drawing obtained by the automatic design system. Concretely the visual inspection, or the like is conducted by the designer, or the like to check whether or not this drawing is correct. Unless this drawing checking work is applied correctly, it is impossible to say that the design work has been completed. In this way, improvement in efficiency of the drawing checking work cannot be achieved even in the automatic design. The drawing checking work may be applied to all matters drawn on the drawing. In particular, since it is possible that numerical values as the manually input standard specifications have been input in error, these numerical values must be checked more carefully than the numerical values computed by the automatic design system. In other words, the numerical values to be computed by the automatic design system are computed automatically in compliance with predetermined output value computing information based on the manually input numerical values. Thus, when an error is produced in the computed numerical values, such error is always caused by the error in the manually input numerical values. Therefore, particularly attention must be paid to the manually input numerical values in the drawing checking work.

Meanwhile, the proposals capable of executing the drawing checking work effectively by displaying varied locations in an easy-discriminate way when dimension values or shapes are varied in the drawing that has already been prepared by using the CAD (Computer-Aided Design) system have been put forth (see JP-A-11-338895, JP-A-11-338891, JP-A-2001-134632, JP-A-2001-202402, for example). However, such CAD system is different from the automatic design system in which the automatic design is made based on the input numerical values and as a result the drawing is made. Therefore, the CAD system does not at all contribute to improvement in efficiency of the drawing checking work applied to the drawing that was made by the automatic design system.

### DISCLOSURE OF THE INVENTION

The present invention has been made in view of the above circumstances, and it is an object thereof to provide an automatic design system, an automatic design method, and an automatic design program, which can make easy a check of drawing and thus can achieve an improvement in efficiency in a drawing checking work.

(1) In order to attain the above object, an automatic design system according to the present invention, includes

an automatic designing means for computing output value information in compliance with output value computing information containing computational expressions, based on input value information required for automatic design of a product;

a draughting information forming means for forming draughting information to display the input value information, the output value information, and a drawing showing a shape based on the input value information and the output value information; an image displaying means for displaying a drawing based on the draughting information; and

an attribute changing means for changing a display attribute on a drawing displayed by the image displaying means such that a display mode of the input value information is made different distinguishably from display modes of other information.

(2) It is preferable that, in the automatic design system according to (1), when the output value information is changed, the attribute changing means changes the display attribute on the drawing displayed by the image displaying means such that a display mode of changed output value information is made different distinguishably from display modes of other output value information.

(3) It is preferable that, in the automatic design system according to (2), the attribute changing means changes the display attribute such that a display mode of a shape of a portion that is changed following upon change of the output value information is made different distinguishably from display modes of shapes of other portions.

If the automatic design system is constructed as given in (1), a display mode of the input value information and a display mode of the output value information on a drawing are made different distinguishably mutually according to the display attribute changed by the attribute changing means. Therefore, the input value information can be easily checked while looking at the shape, and thus improvement in efficiency of the drawing checking work can be achieved.

Further, if the automatic design system is constructed as given in (2), a display mode of the changed output value information and a display mode of the unchanged output value information are made different distinguishably mutually according to the display attribute changed by the attribute changing means. Therefore, the changed output value information can be easily checked while looking at the shape, and thus improvement in efficiency of the drawing checking work can be achieved.

Moreover, if the automatic design system is constructed as given in (3), a display mode of the shape of the portion changed based on the changed output value information and display modes of other portions are made different distinguishably mutually according to the display attribute changed by the attribute changing means. Therefore, not only the changed output value information but also the shape portion changed following upon that change can be easily checked and thus improvement in efficiency of the drawing checking work can be achieved.

(4) In order to attain the above object, an automatic design method according to the present invention, includes an automatic designing step of computing output value information in compliance with output value computing information containing computational expressions, based on input value information required for automatic design of a product;

a draughting information forming step of forming draughting information to display the input value information, the output value information, and a drawing showing a shape based on the input value information and the output value information;

an image displaying step of displaying a drawing based on the draughting information; and

an attribute changing step of changing a display attribute on a drawing displayed by the image displaying step such that a display mode of the input value information is made different distinguishably from display modes of other information.

(5) It is preferable that, in the automatic design method according to (4), when the output value information is changed, the attribute changing step changes the display attribute on the drawing displayed by the image displaying step such that a display mode of changed output value information is made different distinguishably from display modes of other output value information.

(6) It is preferable that, in the automatic design method according to (5), the attribute changing step changes the display attribute such that a display mode of a shape of a portion that is changed following upon change of the output value information is made different distinguishably from display modes of shapes of other portions.

If the automatic design method is constructed as given in (4), a display mode of the input value information and a display mode of the output value information on a drawing are made different distinguishably mutually according to the display attribute changed by the attribute changing step. Therefore, the input value information can be easily checked while looking at the shape, and thus improvement in efficiency of the drawing checking work can be achieved.

Further, if the automatic design method is constructed as given in (5), a display mode of the changed output value information and a display mode of the unchanged output value information are made different distinguishably mutually according to the display attribute changed by the attribute changing step. Therefore, the changed output value information can be easily checked while looking at the shape, and thus improvement in efficiency of the drawing checking work can be achieved.

Moreover, if the automatic design method is constructed as given in (6), a display mode of the shape of the portion changed based on the changed output value information and display modes of other portions are made different distinguishably mutually according to the display attribute changed by the attribute changing step. Therefore, not only the changed output value information but also the shape portion changed following upon that change can be easily checked and thus improvement in efficiency of the drawing checking work can be achieved.

(7) In order to attain the above object, an automatic design program according to the present invention causes a computer to execute

an automatic designing process of computing output value information in compliance with output value computing information containing computational expressions, based on input value information required for automatic design of a product,

a draughting information forming process of forming draughting information to display the input value information, the output value information, and a drawing showing a shape based on the input value information and the output value information,

an image displaying process of displaying a drawing based on the draughting information, and

an attribute changing process of changing a display attribute on a drawing displayed by the image displaying step such that a-display mode of the input value information is made different distinguishably from display modes of other information.

(8) It is preferable that, in the automatic design program according to (7), when the output value information is changed, the attribute changing process changes the display attribute on the drawing displayed by the image displaying process such that a display mode of changed output value information is made different distinguishably from display modes of other output value information.

(9) It is preferable that, in the automatic design program according to (8), the attribute changing process changes the display attribute such that a display mode of a shape of a portion that is changed following upon change of the output value information is made different distinguishably from display modes of shapes of other portions.

If the automatic design program which causes the computer to execute processes is constructed as given in (7), a display mode of the input value information and a display mode of the output value information on a drawing are made different distinguishably mutually according to the display attribute changed by the attribute changing process. Therefore, the input value information can be easily checked while looking at the shape, and thus improvement in efficiency of the drawing checking work can be achieved.

Further, if the automatic design program which causes the computer to execute processes is constructed as given in (8), a display mode of the changed output value information and a display mode of the unchanged output value information are made different distinguishably mutually according to the display attribute changed by the attribute changing process. Therefore, the changed output value information can be easily checked while looking at the shape, and thus improvement in efficiency of the drawing checking work can be achieved.

Moreover, if the automatic design program which causes the computer to execute processes is constructed as given in (9), a display mode of the shape of the portion changed based on the changed output value information and display modes of other portions are made different distinguishably mutually according to the display attribute changed by the attribute changing process. Therefore, not only the changed output value information but also the shape portion changed following upon that change can be easily checked and thus improvement in efficiency of the drawing checking work can be achieved.

Here, the recording medium on which the above automatic design program according to the present invention is recorded, i.e., a computer-readable recording medium on which the program that causes the computer to execute processes containing the process set forth in (7), (8), or (9) is recorded may be formed. It is needless to say that such recording medium can achieve the excellent effects and advantages similar to the automatic design program according to the present invention.

As an example of the computer-readable recording medium, a semiconductor recording medium such as ROM (i.e., Read Only Memory), RAM (i.e., Random Access Memory), or the like, an optical recording medium such as DVD (i.e., Digital Versatile Disk)-ROM, DVD-RAM, CD (i.e., Compact Disc)-ROM, CD-RW (i.e., Rewritable), or the like, a magnetic recording medium such as a hard disk drive, a floppy disk, or the like, and a magneto-optical recording medium such as MO (i.e., Magneto Optical Disk),or the like can be listed. But any recording medium can be employed if such medium is the computer-readable recording medium. Accordingly, a recording/reading device that is fitted in with the concerned recording medium may be provided appropriately to the computer to fit to the employed recording medium.

As described above, according to the present invention, since the formed drawing is easy to check, improvement in efficiency of the drawing checking work can be achieved.

### BRIEF DESCRIPTION OF THE DRAWINGS

FIG. 1 is a view showing a schematic configuration of an embodiment of an automatic design system according to the present invention,

FIG. 2 is a view showing an example of a chamfering dimension specifying table stored in a database of the automatic design system of the present invention,

FIG. 3 is a view showing an example of a drawing on which a shape and dimension variables of a ball bearing obtained by the present embodiment are displayed,

FIG. 4 is a view showing a flowchart of schematic operations taken when the automatic design system of the present invention makes an automatic design of a ball bearing,

FIG. 5 is a view showing a design condition input screen that an image displaying means displays when standard specification information are input from an inputting means of the automatic design system of the present invention,

FIG. 6 is a view showing an automatic designing process of detailed portions of the ball bearing by the automatic design system of the present invention,

FIG. 7 is a view showing an example of draughting information formed by a draughting information forming means,

FIG. 8 is a view showing a display selecting screen of a display selecting means,

FIG. 9 is a view showing a configurative example of a particular system of the automatic design system of the present invention,

FIG. 10 is a view showing a drawing on which a shape and dimension variables of a ball bearing obtained by Example 1 are displayed,

FIG. 11 is a view showing an operational flowchart of Example 1,

FIG. 12 is a view showing an input screen of standard specification information of Example 1,

FIG. 13 is a view showing an automatic computing process of dimensional values in Example 1,

FIG. 14 is a view showing an example of a screen on which the standard specification information are highlighted and computed numerical values (i.e., output value information) are normally displayed,

FIG. 15 is a view showing a drawing on which a shape and dimension variables of a ball bearing obtained by Example 2 are displayed,

FIG. 16 is a view showing an operational flowchart of Example 2,

FIG. 17 is a view showing an input screen of user's dimension inputs in Example 2,

FIG. 18 is a view showing an example of a screen on which the standard specification information and user's input dimension values (i.e., numerical value replaced with the output value information) are highlighted and computed numerical values (i.e., output value information that have not been changed) are normally displayed,

FIG. 19 is a view showing a drawing on which a shape, dimension variables, and the number of balls of a ball bearing obtained by Example 3 are displayed,

FIG. 20 is a view showing an operational flowchart of Example 3,

FIG. 21 is a view showing an input screen of standard specification information of Example 3,

FIG. 22 is a view showing an automatic designing process of detailed portions of the ball bearing in Example 3,

FIG. 23 is a view showing a lifetime computing process,

FIG. 24 is a view showing a target value confirming process,

FIG. 25 is a view showing a dimension value confirming screen,

FIG. 26 is a view showing an input screen of correction dimension inputs, and

FIG. 27 is a view showing an example of a screen on which the standard specification information and user's input numerical values (i.e., numerical value replaced with the output value information) are highlighted and computed numerical values (i.e., output value information that have not been changed) are normally displayed.

In above Figures, a reference symbol 1 denotes an inputting means, 2 database, 3 automatic designing means, 4 draughting information forming means, 5 display selecting means, 6 attribute changing means, and 7 image displaying means.

### BEST MODE FOR CARRYING OUT THE INVENTION

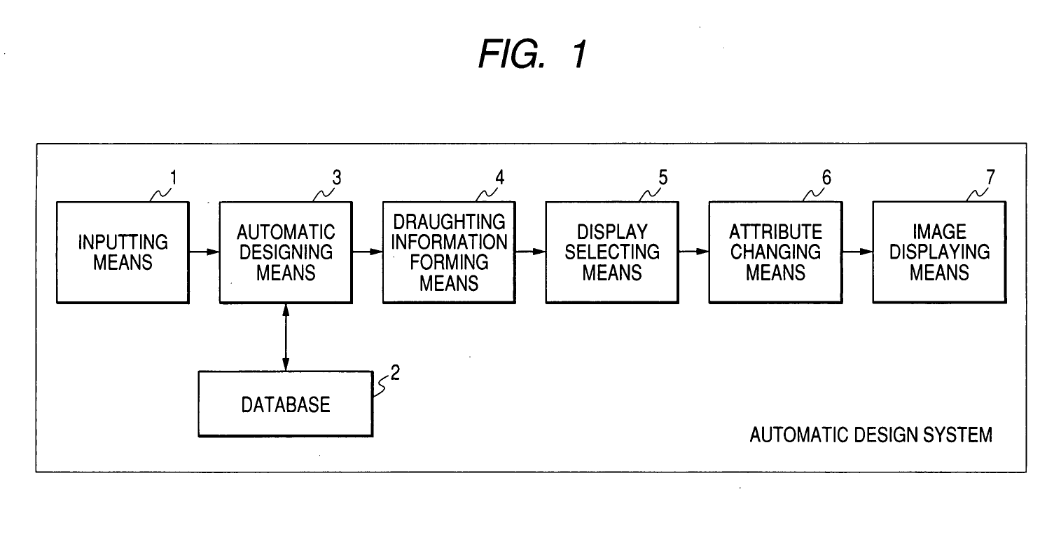

An embodiment according to the present invention will be explained in detail with reference to FIG. 1 to FIG. 27, while taking a design of a ball bearing as an example, hereinafter.

An automatic design system shown in FIG. 1 includes an inputting means 1, a database 2, an automatic designing means 3, a draughting information forming means 4, a display selecting means 5, an attribute changing means 6, and an image displaying means 7.

The inputting means 1 is the device that the operator such as the designer, or the like uses to input the standard specifications information (i.e., input value information) required for automatic design of a product, i.e., a ball bearing, as an object of the automatic design.

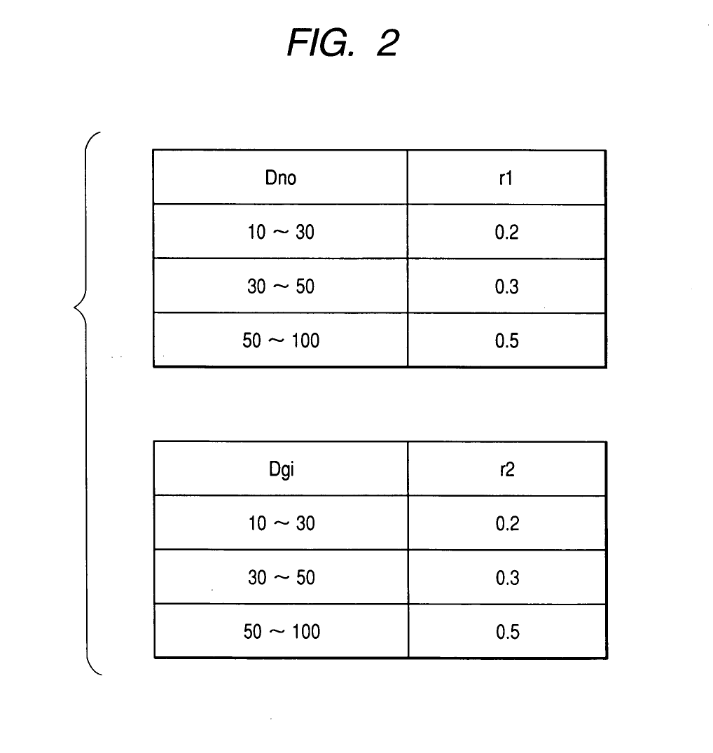

The database 2 stores output value computing information containing computational expressions, and the like necessary for the automatic design. In addition to the computational expression, computing procedures, design standards, a productive capacity of the factory, a various dimensions specifying table, and the like are contained in the output value computing information. FIG. 2 is a view showing an example of a chamfering dimension specifying table stored in the database 2.

The automatic designing means 3 makes the automatic design by reading the output value computing information from the database 2, then executing a computation based on numerical values being input from the inputting means 1 as the standard specifications information according to procedures previously determined by the read output value computing information, and then deciding all dimensions, etc. up to detailed portions of the shapes of the product. In this manner, in the automatic designing means 3, numerical values such as dimensions, etc. of shapes of the product are computed as the output value information by an automatic designing process.

The draughting information forming means 4 executes a process of forming the draughting information that are used to output (i.e., display) numerical values input from the inputting means 1 as the standard specifications information, numerical values output from the automatic designing means 3 as output value information, and a drawing showing the shape of the product based on the input value information and the output value information, onto a display screen of the display such as CRT (i.e., Cathode-Ray Tube), LCD (i.e., Liquid Crystal Display), or the like of the image displaying means 7 or onto the printing recording medium such as the paper, or the like.

The display selecting means 5 is the means that is used to select the contents of the drawing displayed on the image displaying means 7. More concretely, the display selecting means 5 functions to select the display of the drawing that shows the output value information and the shape (i.e., standard display), the display of the drawing that shows the input value information in addition to them (i.e., input value display), the display of the drawing that shows changed numerical values as the output value information (in other words, replaced numerical values) and the shape of the portion to be changed following upon the above change (i.e., changed portion display), or both displays of the input value display and the changed portion display. In this case, as to the changed portion display, the display selecting means 5 may function to select only the display of the changed numerical values as the output value information or only the display of the shape of the portion to be changed following upon the above change.

The attribute changing means 6 is the means that is used to change (i.e., set) all display attributes of the input value information and/or the changed output value information and (or) the shape of the portion to be changed following upon the above change such that, when at least one of the input value display and the changed portion display is selected by the display selecting means 5, display modes of the input value information and/or the changed output value information and (or) the shape of the portion to be changed following upon the above change on the drawing are made different distinguishably from other display modes. In this case, the attribute changing means 6 may function to change (i.e., set) the display attributes of a part of information of the input value information and/or the changed output value information and (or) the shape of the portion to be changed following upon the above change.

Here, if the input value information, the changed output value information, and the shape of the portion to be changed following upon the above change can be discriminated from others (i.e., the unchanged output value information and the shape of the unchanged portion) on the drawing, the display attributes of the input value information, the changed output value information, and the shape of the portion to be changed following upon the above change may be changed. It is needless to say that the display attributes of others (i.e., the unchanged output value information and the shape of the unchanged portion) may be changed alternately. As the particular example of the display attribute, display color, grayout, shading, marking, character size, font, display position, and the like can be listed. In short, any display mode may be employed if the locations input or changed by the operator can be discriminated from the locations obtained by the automatic design.

The image displaying means 7 is the means that displays the drawing on the display screen or the printing recording medium in compliance with the display method selected by the display selecting means 5 and the display attribute changed by the attribute changing means 6, based on the draughting information formed by the draughting information forming means 4.

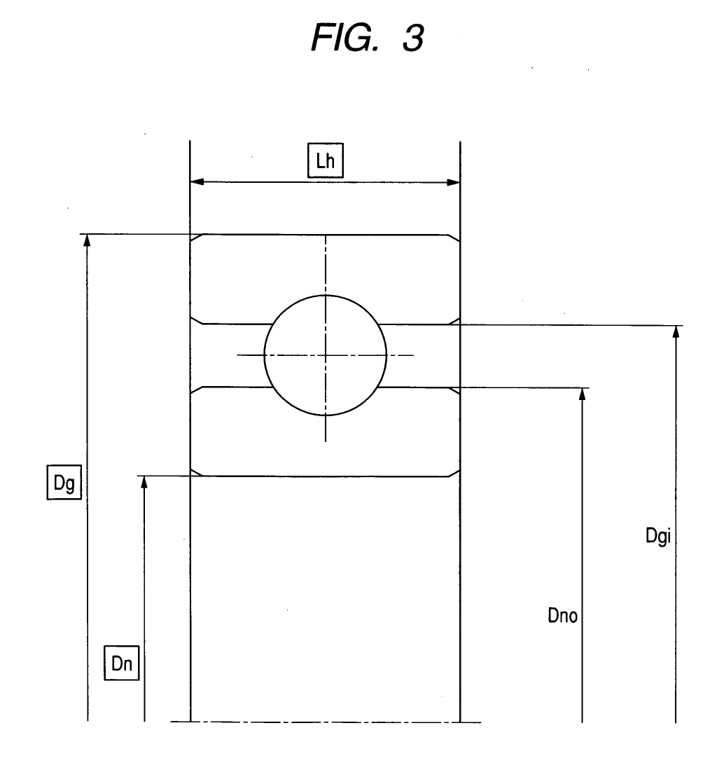

FIG. 3 is a view showing an example of the drawing on which a shape and dimension variables of a ball bearing obtained by the present embodiment are displayed. In FIG. 3, an inner diameter Dn of an inner ring, an outer diameter Dg of an outer ring, and a height Lh are the standard specifications information, and are the numerical values that are input from the inputting means 1 by the operator such as the designer, or the like. An outer diameter Dno of an inner ring and an inner diameter Dgi of an outer ring are computed values that are acquired by the automatic design. Since Dn, Dg, and Lh are the input value information, their display modes are different from those of Dno and Dgi as the output value information, as shown in FIG. 3, and thus a □ mark is put to them to highlight. In this manner, Dn, Dg, and Lh can be discriminated from Dno and Dgi.

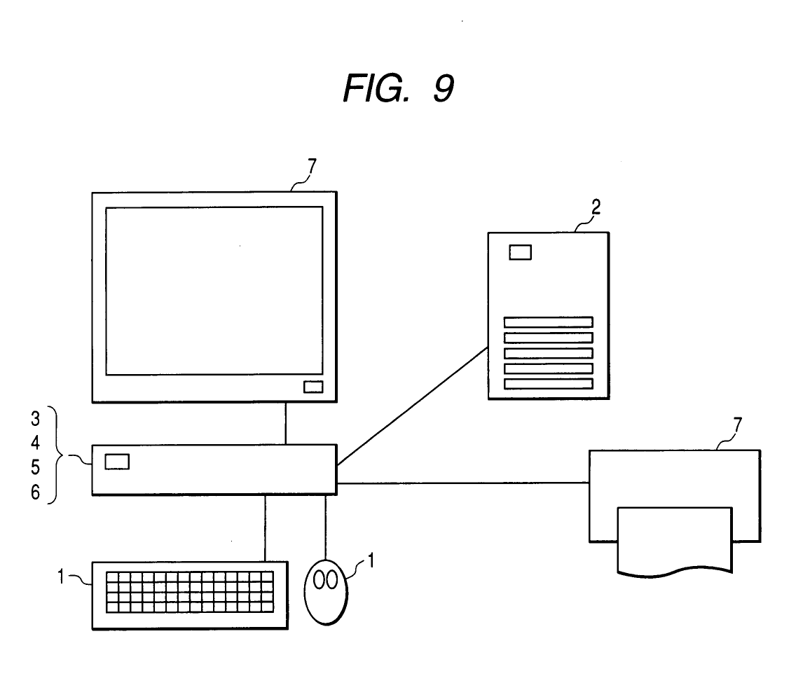

A configurative example of a particular system of the automatic design system having the above configuration is shown in FIG. 9. In FIG. 9, a keyboard and a mouse are shown as the inputting means 1, a database server is shown as the database 2, a computer such as a personal computer, or the like is shown as the automatic designing means 3, the draughting information forming means 4, the display selecting means 5, and the attribute changing means 6, and a display device and a printer are shown as the image displaying means 7. These means are connected to communicate with each other via cable.

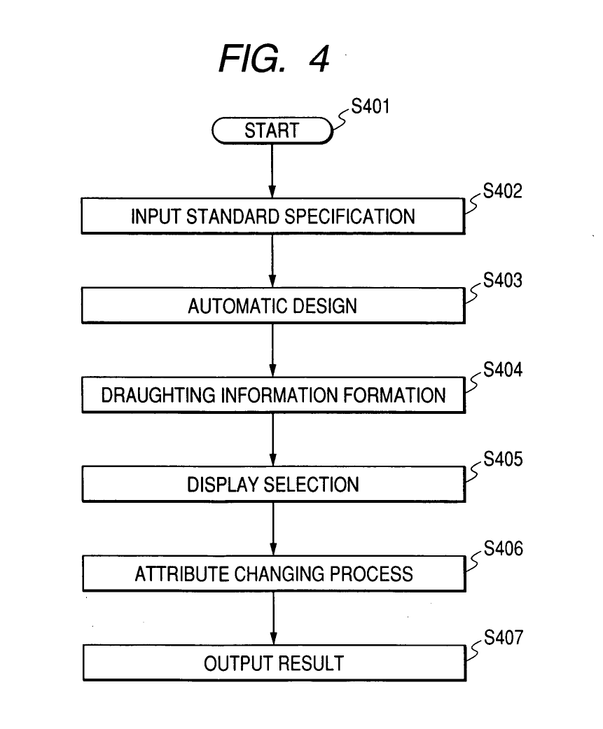

Next, operations of the automatic design system taken when the automatic design of the ball bearing is executed will be explained with reference to FIG. 4 to FIG. 8 hereunder.

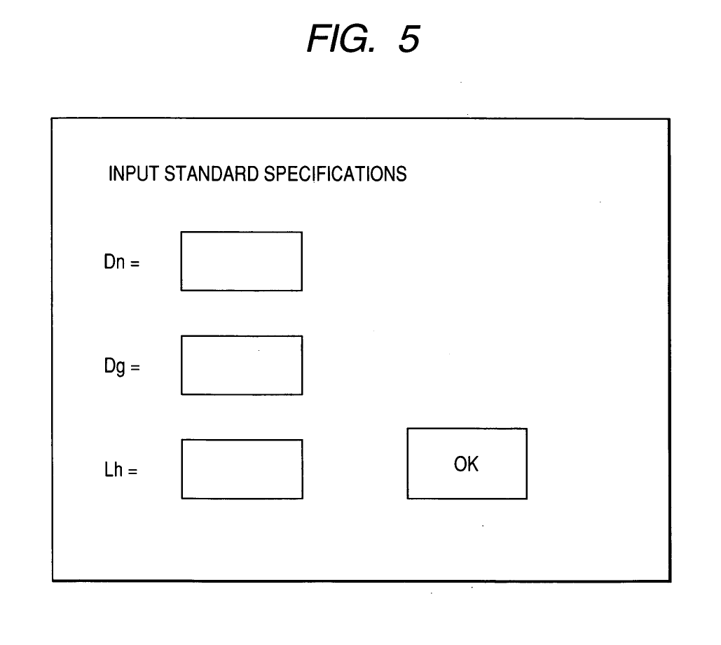

An operation of the automatic design system is started (i.e., step S401). The operator such as the designer, or the like inputs respective dimension values of the ball bearing from the inputting means 1 (i.e., step S402). The operator such as the designer, or the like, when inputs respective dimension values, inputs sequentially a Dn value, a Dg value, and an Lh value as the standard specifications, while looking at a screen shown in FIG. 5. Then, the inputs are defined by clicking an “OK” button after the standard specifications information are input.

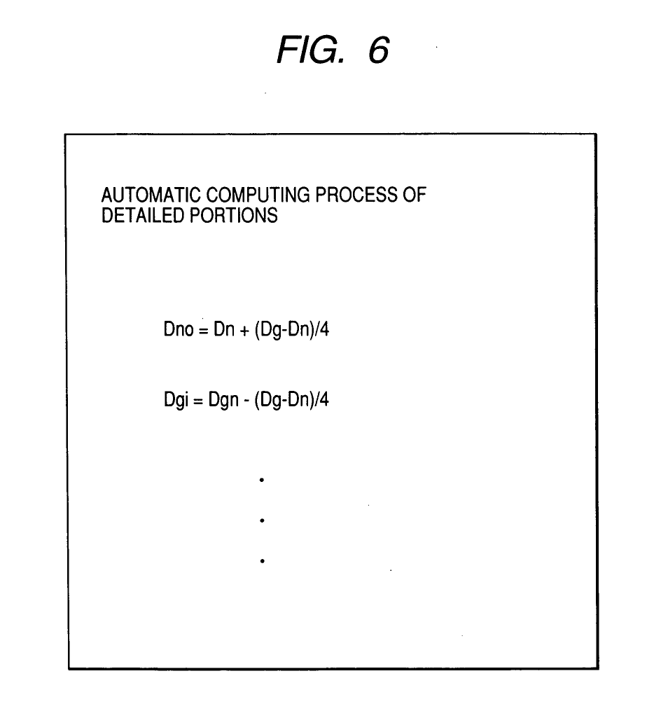

Then, the automatic designing means 3 executes the automatic design by reading the output value computing information from the database 2, then executes a computation according to procedures determined previously by the read output value computing information based on the standard specifications information being input in step S402, and then deciding all dimensions, etc. up to fine portions of the shape of the product (i.e., step S403). Concretely, the automatic designing means 3, when makes the automatic design, computes Dno, Dgi, etc. as the dimension values of the detailed portions based on respective values Dn, Dg, Lh input in step S402 in compliance with computational expressions shown in FIG. 6.

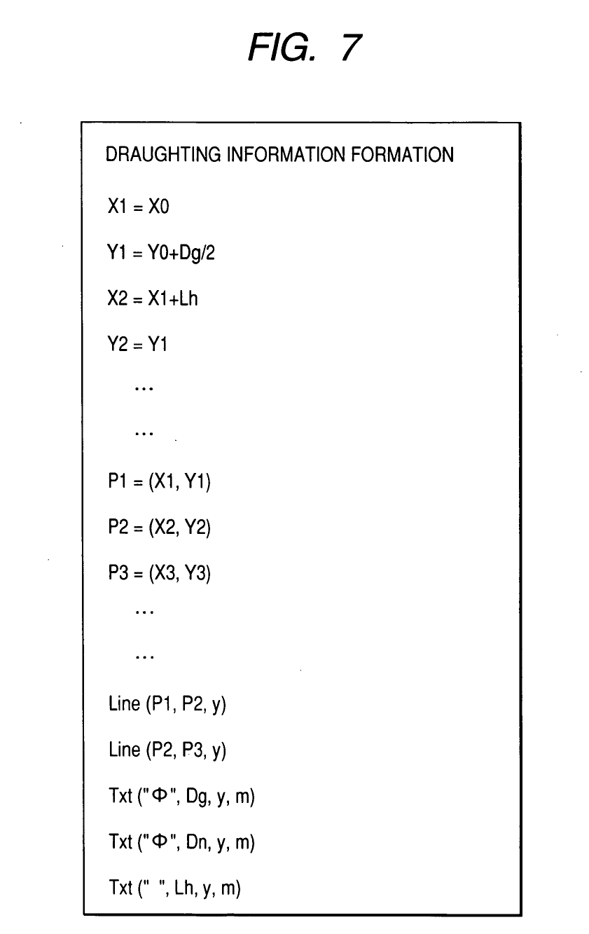

Then, the draughting information forming means 4 executes a process of forming the draughting information that are used to display the standard specification information input in step S402, the output value information computed in step S403, and the drawing showing the shape of the product based on the standard specifications information and the output value information (i.e., step S404). FIG. 7 is a view showing an example of the draughting information formed by the draughting information forming means.

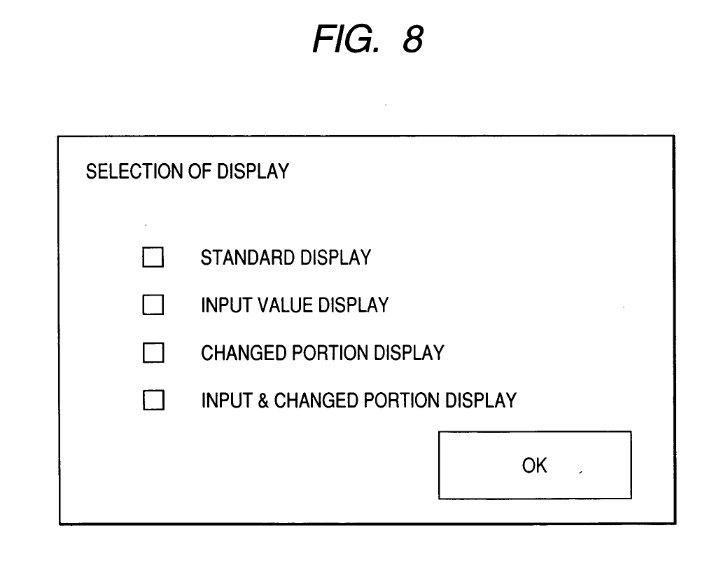

Then, the contents of the drawing to be displayed on the image displaying means 7 are selected by the display selecting means 5 (i.e., step S405). Concretely, the operator such as the designer, or the like selects the display method of a favorite drawing while looking at a screen shown in FIG. 8. The selection is defined by clicking an “OK” button after the display is selected.

Then, the attribute changing means 6 changes all display attributes of the input value information and/or the changed output value information and (or) the shape of the portion to be changed following upon the above change in such a manner that, when at least one of the input value display and the changed portion display is selected in step S405, the display mode of the input value information on the drawing and/or the display modes of the changed output value information and (or) the shape of the portion to be changed following upon the above change on the drawing are made different distinguishably from other display modes (i.e., step S406).

Then, the image displaying means 7 displays the drawing on the display screen or the printing recording medium in accordance with the display method selected in step S405 or the display attributes changed in step S406, based on the draughting information formed in step S404 (i.e., step S407).

A series of operational results in steps S401 to S407 are shown in FIG. 3. As shown in FIG. 3, because Dn, Dg, Lh are manual input values, a □ mark is affixed to them to highlight and, because remaining Dno, Dgi are numerical values obtained by a computation (automatic design), they are normally displayed.

Next, Example 1 where a drawing is automatically made by computing detailed dimension values based on input standard specifications information, Example 2 where a drawing is automatically made by computing detailed dimension values based on input standard specifications information and then setting user's dimensions by the operator, and Example 3 where a drawing is automatically made by executing function computations based on dimensions of respective portions acquired from the input standard specifications information will be explained hereunder.

### EXAMPLE 1

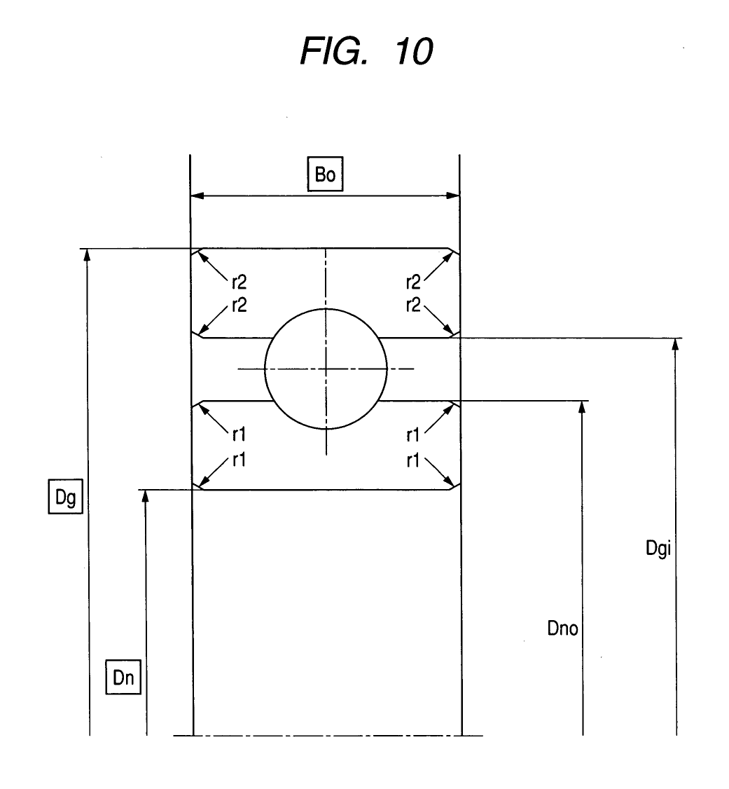

Example 1 of the present embodiment will be explained with reference to FIG. 10 to FIG. 14 hereunder. In FIG. 10, an inner diameter Dn of an inner ring, an outer diameter Dg of an outer ring, and a height Bo are standard specifications information and are the numerical values that are input from the inputting means 1 by the operator such as the designer, or the like. An outer diameter Dno of an inner ring, an inner diameter Dgi of an outer ring, an R radius r1 of plural portions, and an R radius r2 of plural portions are detailed dimension values (i.e., computed values) that are acquired as the output value information by the automatic design. Since Dn, Dg, and Bo are input value information, their display modes are different from display modes of Dno, Dgi, r1 and r2 as the output value information, as shown in FIG. 10, and they are highlighted by affixing a □ mark. In this manner, Dn, Dg, and Lh can be discriminated from Dno, Dgi, r1 and r2.

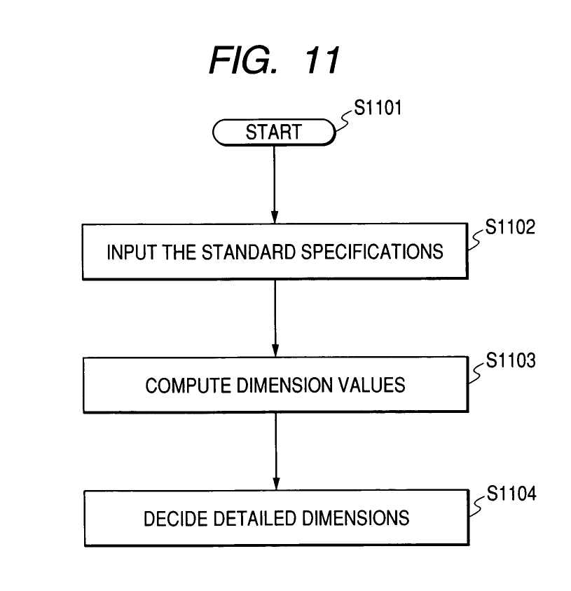

Next, operations taken when a ball bearing shown in FIG. 10 is designed by using the automatic design system shown in FIG. 1 will be explained with reference to a flowchart shown in FIG. 11 hereunder.

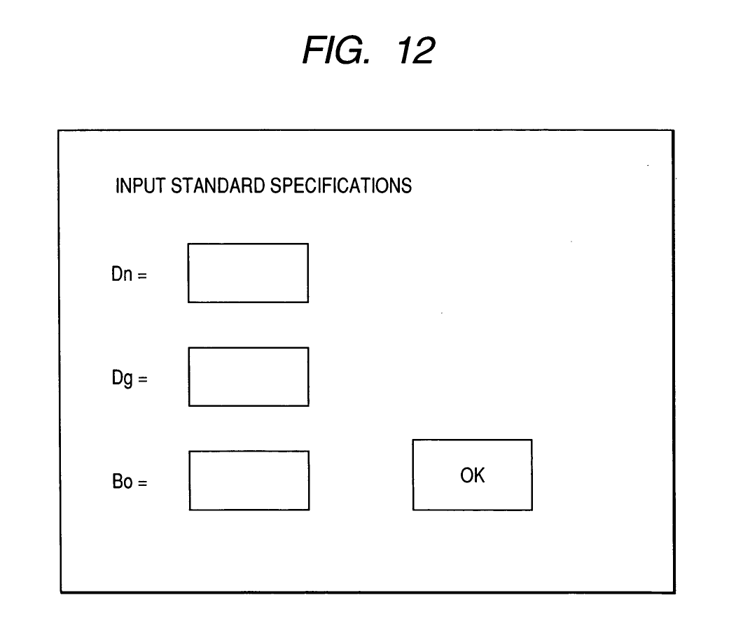

The automatic design is started (step S1101). In step S1102, when the operator such as the designer, or the like inputs the standard specifications, such operator inputs a Dn value, a Dg value, and a Bo value sequentially while looking at a screen shown in FIG. 12. After the standard specification information are input, the inputs are defined by clicking an “OK” button.

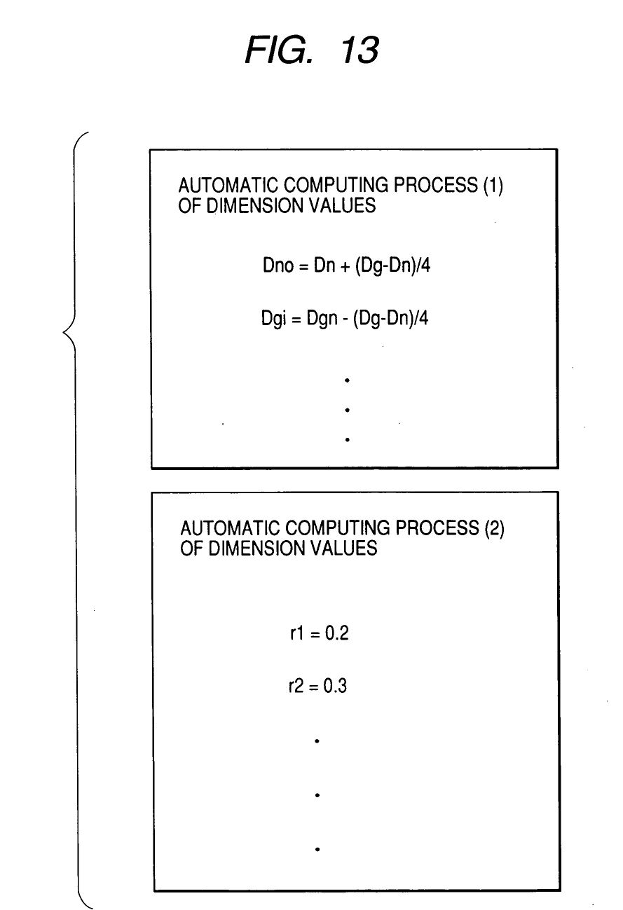

In step S1103, the automatic designing means 3 computes Dno and Dgi as the dimensions of the detailed portions in accordance with the computational expressions shown in FIG. 13 based on respective values Dn, Dg, Bo input in step S1102, and decides r1 and r2 in accordance with the chamfering dimension specifying table shown in FIG. 2 based on the computed dimensions of Dno and Dgi.

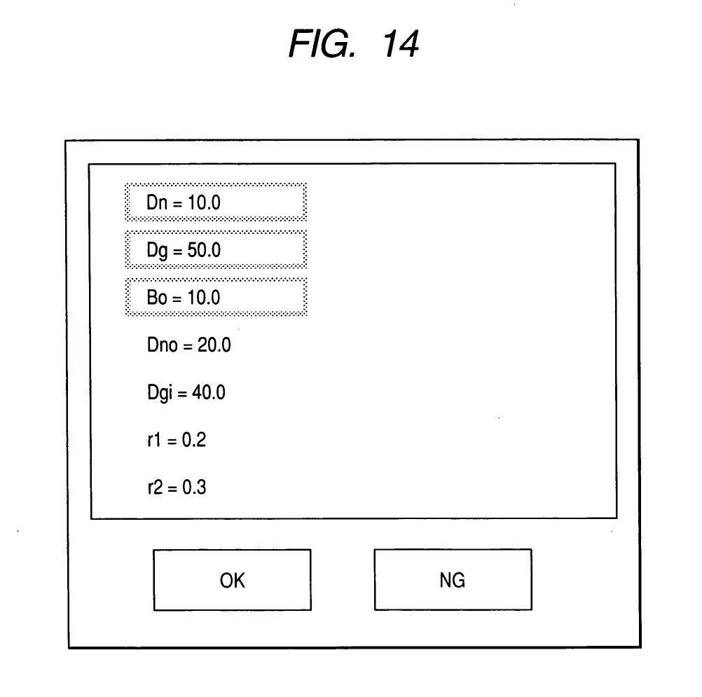

In step S1104, the draughting information, and the like are decided according to the same procedures as those in steps S404 to S407 shown in FIG. 4, and then a drawing is output. In the present embodiment, the operator can monitor a screen on which, as shown in FIG. 14, peripheries of the standard specification information Dn, Dg, Bo are highlighted by adding the shading respectively but the computed numerical values (i.e., output value information) Dno, Dgi, r1, r2 are normally displayed (the shape of the product is not displayed) before the drawing shown in FIG. 10 is displayed.

According to Example 1 of the present embodiment, since the manually input numerical values and the automatically computed numerical values are displayed distinguishably in different display modes, the dimension values that are input in error, and the like are easily found. Also, the manually input numerical values can be easily checked while looking at the shape, and therefore improvement in efficiency of the drawing checking work can be achieved. In Example 1, as shown in FIG. 14, the shading is added to the standard specifications information Dn, Dg, Bo respectively to avoid their display areas but to surround their peripheries. But it is needless to say that the shading can be added to over1ap with the standard specifications information Dn, Dg, Bo themselves respectively.

### EXAMPLE 2

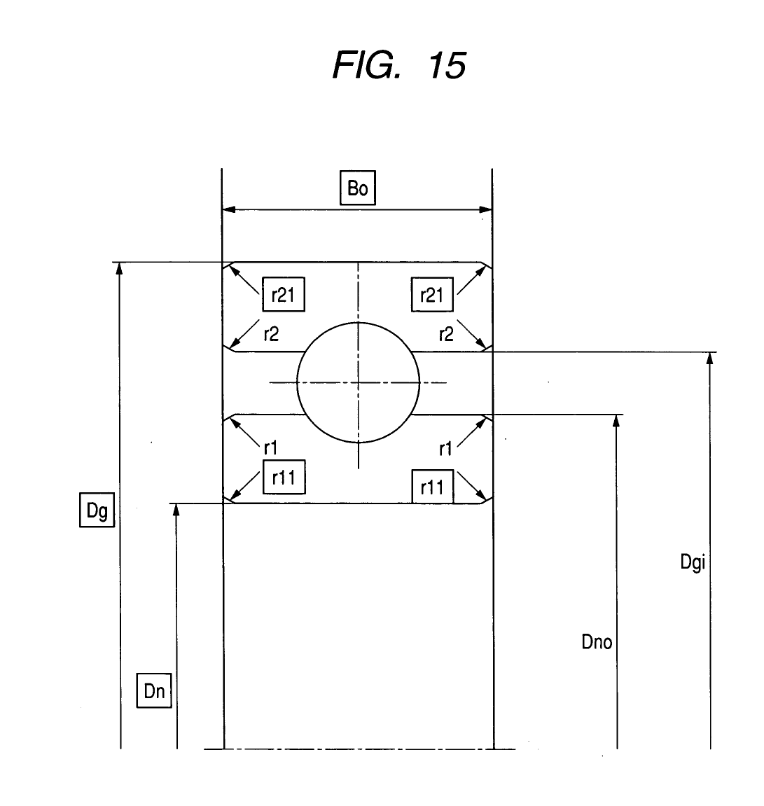

Next, Example 2 of the present embodiment will be explained with reference to FIG. 15 to FIG. 18 hereunder. In Example 2, a drawing is automatically made by computing detailed dimension values based on the input standard specifications information, and then setting the user's dimensions by the operator.

In FIG. 15, an inner diameter Dn of an inner ring, an outer diameter Dg of an outer ring, and a height Bo are the standard specifications information, and are the numerical values that are input from the inputting means 1 by the operator such as the designer, or the like. An outer diameter Dno of an inner ring, an inner diameter Dgi of an outer ring, an R radius r1 of plural portions, and an R radius r2 of plural portions are detailed dimension values (i.e., computed values) that are acquired as the output value information by the automatic design. Also, R radii r11 and r21 of plural portions are the user's input dimension values that are obtained by changing the numerical values computed as the output value information by the automatic design. Since Dn, Dg, and Bo are input value information and r11 and r21 are the numerical values obtained by changing the output value information, their display modes are different from display modes of Dno, Dgi, r1 and r2 as the output value information, as shown in FIG. 15, and they are highlighted by affixing a □ mark. In this manner, Dn, Dg, Lh, r11 and r21 can be discriminated from Dno, Dgi, r1 and r2. Although not shown in FIG. 15, R-shaped portions such as the R radius r11 and the R radius r21, which are changed following upon another change, and arrows indicating these portions are also highlighted distinguishably appropriately.

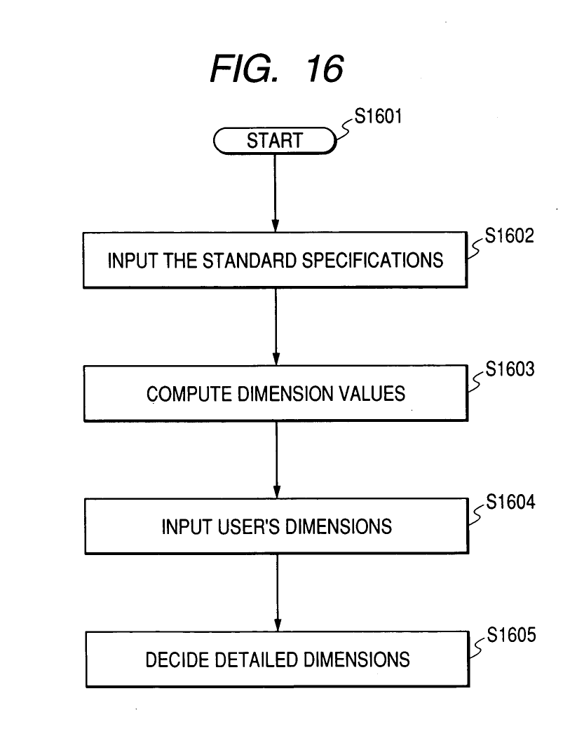

Next, operations taken when the ball bearing shown in FIG. 15 is designed by using the automatic design system shown in FIG. 1 will be explained with reference to a flowchart shown in FIG. 16 hereunder.

Since operations in steps S1601 to S1603 are similar to those in steps S1101 to S1103 shown in FIG. 11, their explanation will be omitted herein.

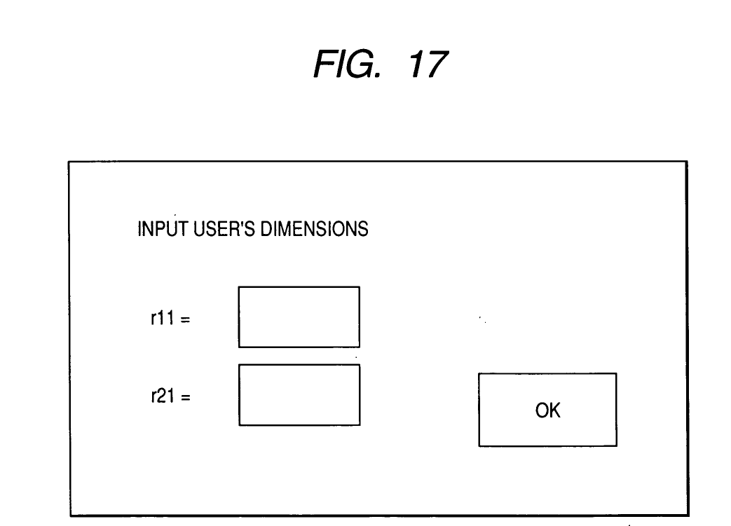

After the dimension values are computed in step S1603, the user's dimensions are input in step S1604. FIG. 17 is a view showing an input screen of the user's dimension inputs in Example 2. When the user's dimensions are to be input, the operator inputs the user's dimension values regarding the shape of the product by inputting sequentially an r11 value and an r21 value while looking at a screen shown in FIG. 17. After the user's dimension values are input, the inputs are defined by clicking an “OK” button.

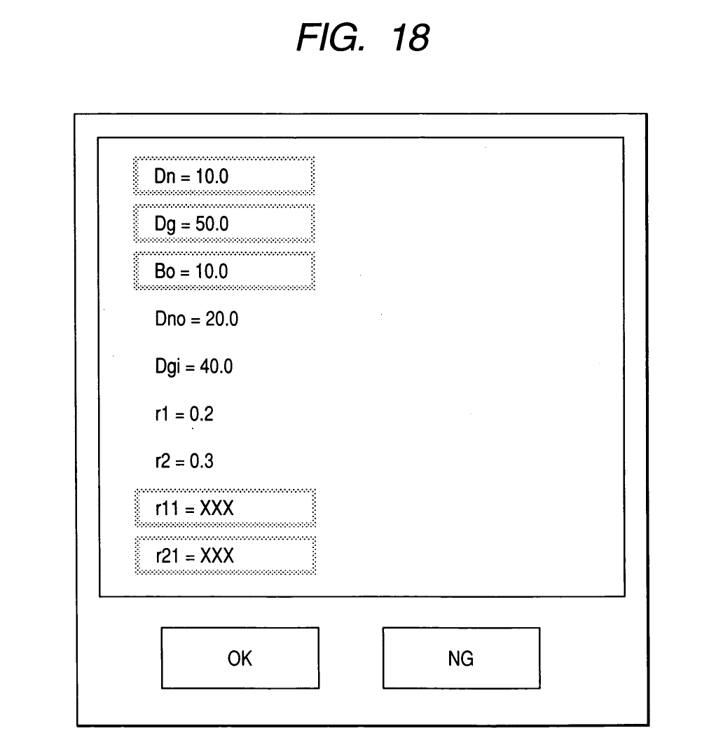

In step S1605, the draughting information, and the like are decided like step S1104, and a drawing is output. In the present embodiment, the operator can monitor a screen on which, as shown in FIG. 18, peripheries of the standard specification information Dn, Dg, Bo and peripheries of the user's input dimension values r11, r21 are highlighted by adding the shading respectively but the computed numerical values (i.e., output value information that have not been changed) Dno, Dgi, r1, r2 are normally displayed (the shape of the product is not displayed) before the drawing shown in FIG. 15 is displayed.

According to Example 2 of the present embodiment, in addition to effects and advantages of above Example 1, the changed output value information can be easily checked while looking at the shape and therefore improvement in efficiency of the drawing checking work can be achieved. Also, not only the changed output value information but also the shape portion changed following upon the above change can be easily checked and therefore improvement in efficiency of the drawing checking work can be achieved. In Example 2, as shown in FIG. 18, the shading is added to the standard specifications information Dn, Dg, Bo and the user's input dimension values r11, r21 respectively to avoid their display areas but to surround their peripheries. But it is needless to say that the shading can be added to over1ap with the standard specifications information Dn, Dg, Bo and the user's input dimension values r11, r21 themselves respectively.

### EXAMPLE 3

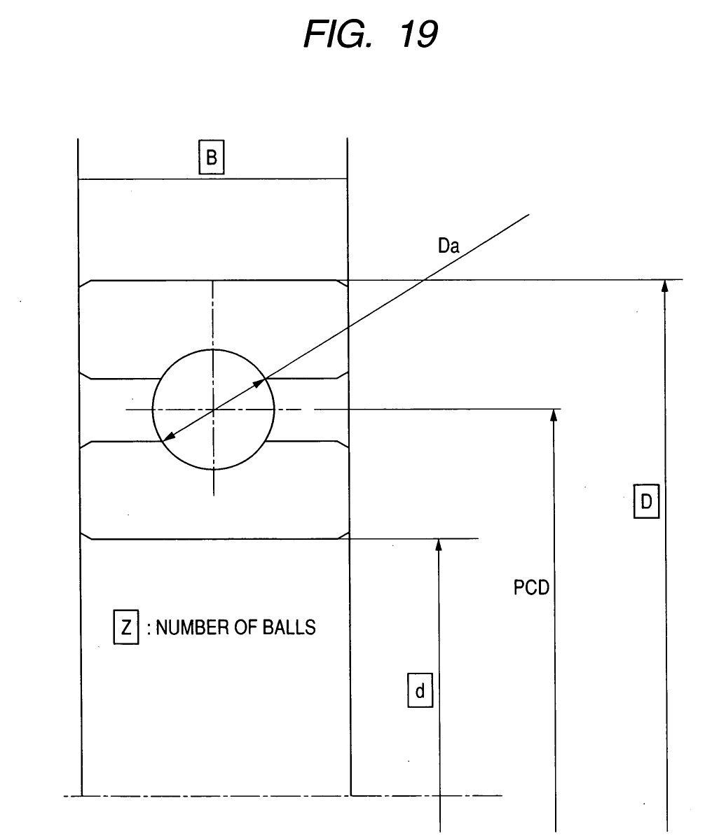

Next, Example 3 of the present embodiment will be explained with reference to FIG. 19 to FIG. 27 hereunder. In Example 3, a drawing is automatically made by executing function computation based on dimensions of respective portions acquired from the input standard specification information.

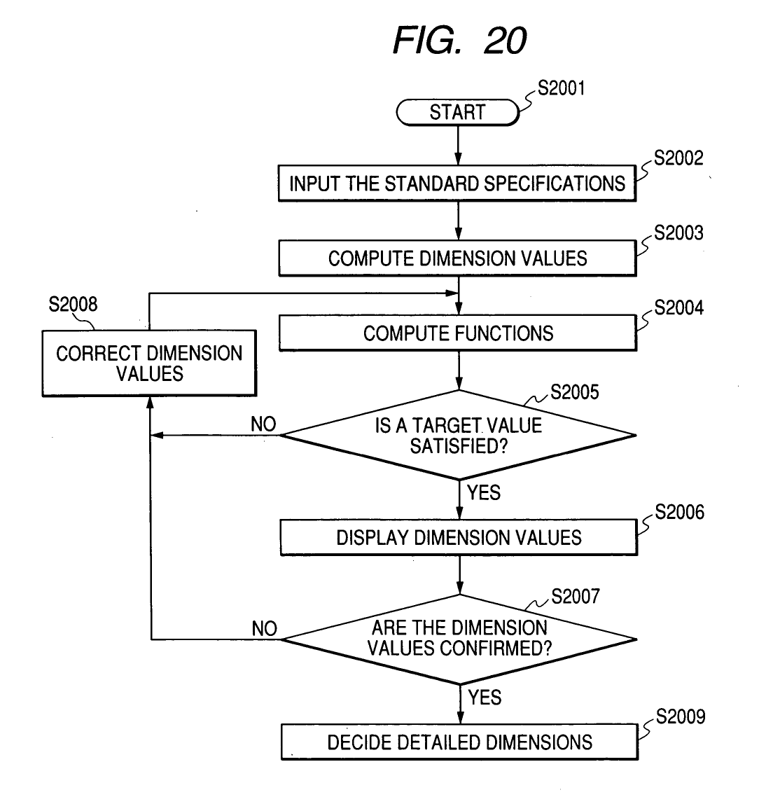

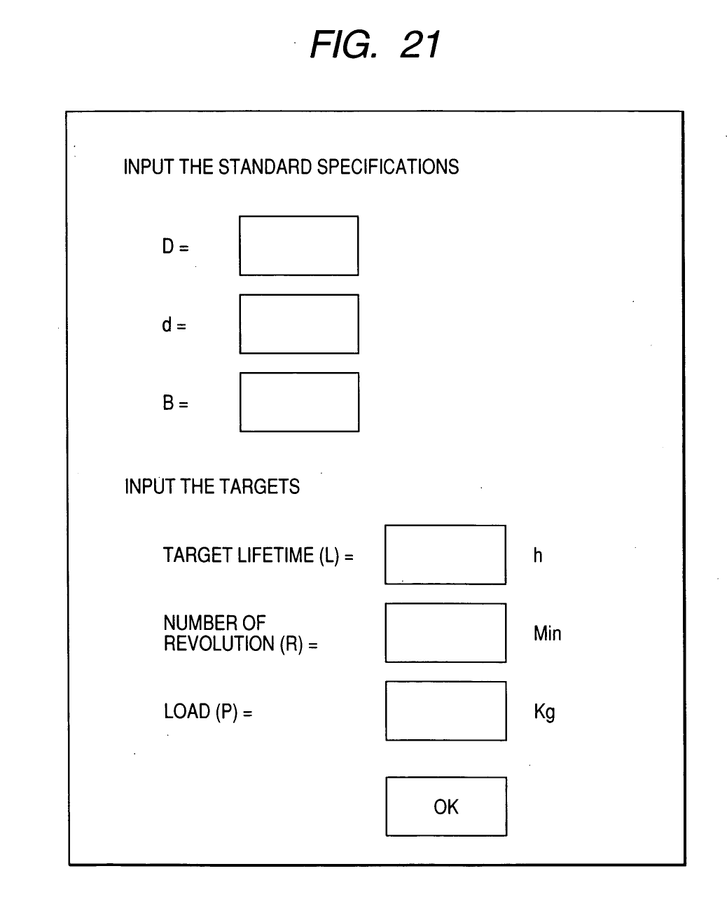

In FIG. 20, the automatic design is started (i.e., step S2001). In step S2002, when the standard specifications and the target values are to be input by the operator such as the designer, or the like, the operator input sequentially a D value, a d value, and a B value while watching a screen shown in FIG. 21 and then inputs a target lifetime (L) value, a number-of-revolution (R) value, and a load (P) value. After respective numerical values are input, the inputs are defined by clicking an “OK” button.

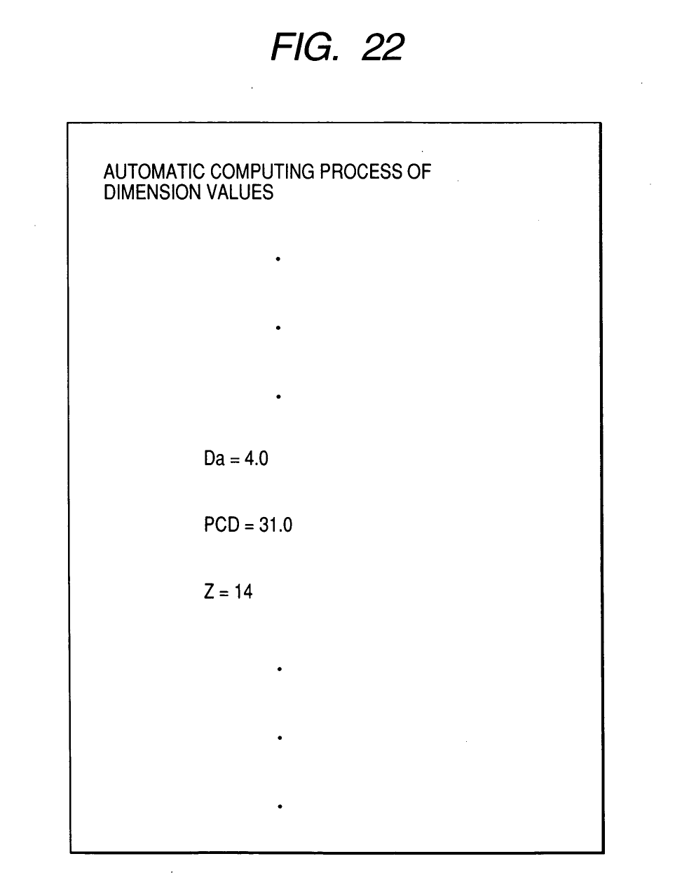

The automatic designing means 3 makes the automatic design by reading the output value computing information from the database 2, then executing a computation based on the standard specifications information and the target value information being input in step S2002 according to procedures previously determined by the read output value computing information, and then deciding all dimensions, etc. up to detailed portions of the shapes of the product (i.e., step S2003). Concretely, the automatic designing means 3, when makes the automatic design, decides dimensions Da, PCD, Z, etc. based on the D, d, B values input in step S2002 and the target lifetime (L) value, the number-of-revolution (R) value, and the load (P) value according to computational expressions shown in FIG. 22.

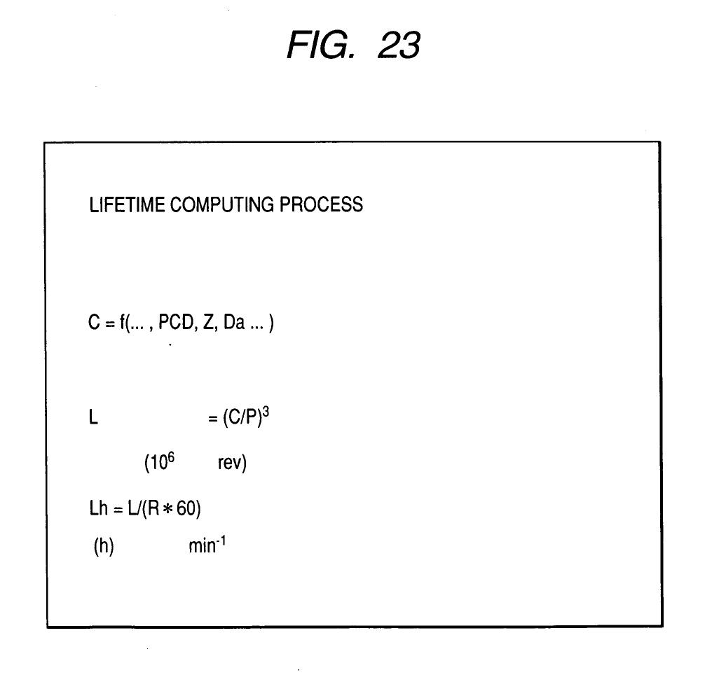

Then, the function computation is executed based on the dimension values computed in step S2003 (i.e., step S2004) In the present embodiment, a lifetime of the ball bearing is computed. FIG. 23 is a view showing a lifetime computing process. In FIG. 23, Da, PCD, Z are the dimension values computed instep S2003, and Lh is a lifetime of the ball bearing computed by Da, PCD, Z.

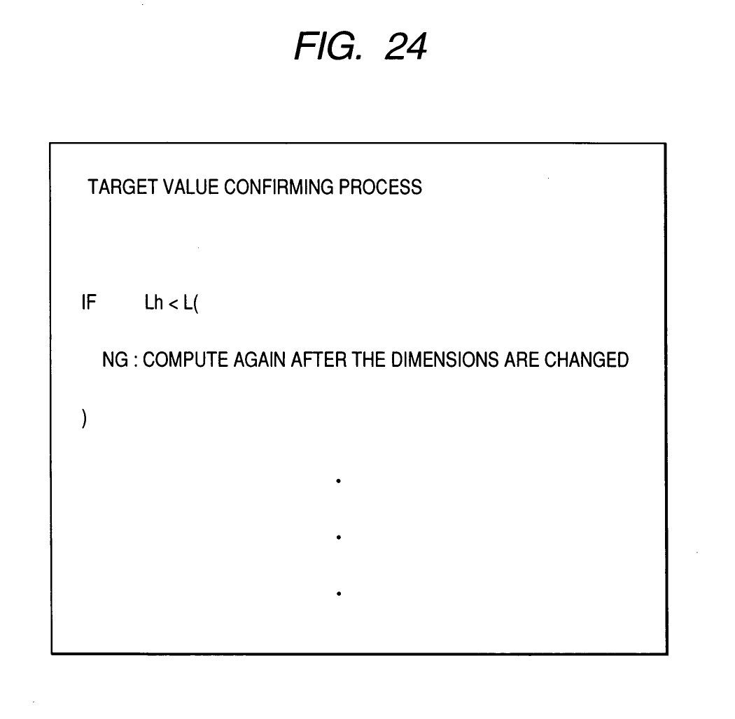

In step S2005, it is decided whether or not a computed lifetime of the ball bearing can satisfy a target lifetime. FIG. 24 is a view showing a target value confirming process.

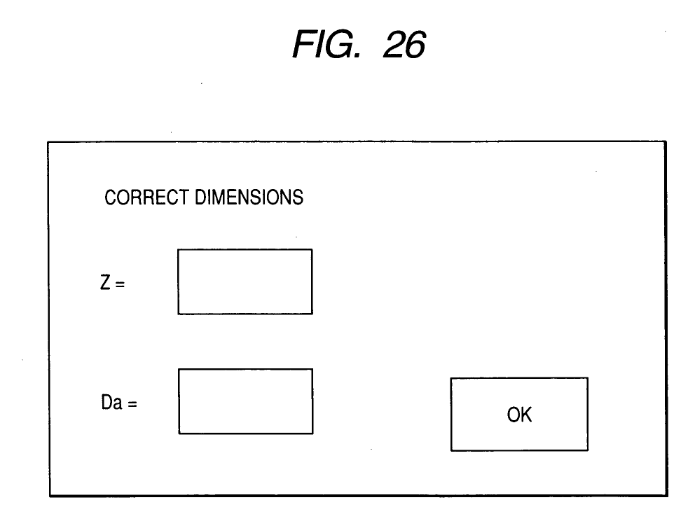

In step S2005, if it is decided that the computed lifetime is below the target lifetime, the dimension values are corrected in step S2008. FIG. 26 is a view showing an input screen of correction dimension inputs. When the operator corrects the dimension values, he or she inputs the number of balls while looking at a dimension input screen shown in FIG. 26. The inputs are defined by clicking an “OK” button after the number of balls is input, and the function computation is carried out once again in step S2004. The operations in steps S2004, S2005 to S2008 to are executed repeatedly until the computed lifetime exceeds the target lifetime.

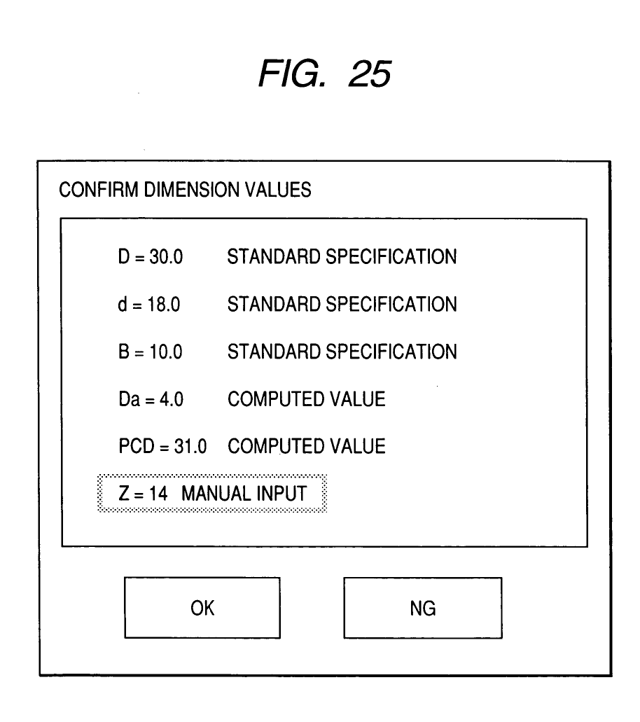

In contrast, in step S2005, if it is decided that the computed lifetime exceeds the target lifetime, the dimension values are displayed in step S2006. FIG. 25 is a view showing a dimension value confirming screen.

In step S2007, the dimension values are confirmed. When the operator confirms the dimension values, such operator checks whether or not the number Z of balls are proper, on the screen shown in FIG. 25.

In step S2007, if the operator clicks an “NG” button while watching the dimension value confirming screen shown in FIG. 25, the number of balls is changed by the manual input in step S2008. Then, the process goes to step S2004. Then, the operations in steps S2004, S2005, S2006, S2007, and S2008 are executed repeatedly until the operator clicks an “OK” button on a screen shown in FIG. 25.

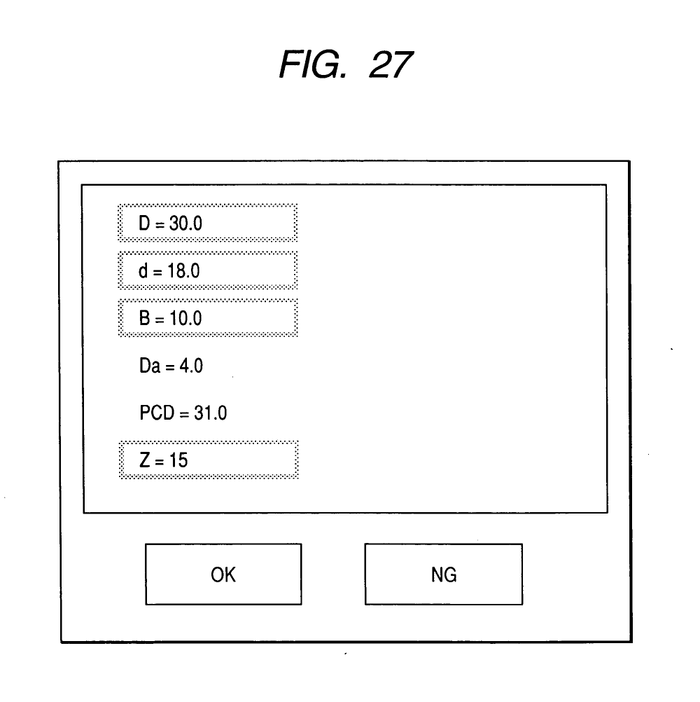

In contrast, in step S2007, if the operator clicks an “OK” button on the dimension value confirming screen shown in FIG. 25, the draughting information, and the like are decided like step S1104 in step S2009, and then a drawing is output. In the present embodiment, the operator can monitor a screen on which, as shown in FIG. 27, peripheries of the standard specification information D, b, B and the user's input numerical value z are highlighted by adding the shading respectively but the computed numerical values (i.e., output value information that have not been changed) Da, PCD are normally displayed (the shape of the product is not displayed) before the drawing shown in FIG. 19 is displayed.

According to Example 3 of the present embodiment, like foregoing Example 2, the changed output value information can be easily checked while looking at the shape and therefore improvement in efficiency of the drawing checking work can be achieved. In Example 3, as shown in FIG. 25 and FIG. 27, the shading is added to the standard specifications information D, d, B and the user's input dimension value z respectively to avoid their display areas but to surround their peripheries. But it is needless to say that the shading can be added to over1ap with the standard specifications information D, d, B themselves and the user's input numerical value z itself respectively.

In the above explanation of the embodiments, design of the simple ball bearing is taken as an example. But it is needless to say that the present invention can be applied similarly to design of a cylindrical roller bearing, a hub bearing, a needle roller bearing, and the like.

The present invention is explained in detail with reference to the particular example. But it is apparent for those skilled in the art that various variations and modifications can be applied without departing from a spirit and a scope of the present invention.

This application is based upon Japanese Patent Application (patent application No. 2004-129990) filed on Apr. 26, 2004; the entire contents of which are incorporated herein by reference.

<Industrial Applicability>

The automatic design system, the automatic design method, the automatic design program, and the recording medium for recording the automatic design program according to the present invention are useful in making the automatic design by using the computer.

1. An automatic design system, comprising:
an automatic designing means for computing output value information in compliance with output value computing information containing computational expressions, based on input value information required for automatic design of a product;
a draughting information forming means for forming draughting information to display the input value information, the output value information, and a drawing showing a shape based on the input value information and the output value information;
an image displaying means for displaying a drawing based on the draughting information; and
an attribute changing means for changing a display attribute on a drawing displayed by the image displaying means such that a display mode of the input value information is made different distinguishably from display modes of other information.

2. An automatic design system, according to claim 1, wherein, when the output value information is changed, the attribute changing means changes the display attribute on the drawing displayed by the image displaying means such that a display mode of changed output value information is made different distinguishably from display modes of other output value information.

3. An automatic design system, according to claim 2, wherein the attribute changing means changes the display attribute such that a display mode of a shape of a portion that is changed following upon change of the output value information is made different distinguishably from display modes of shapes of other portions.

4. An automatic design method, comprising:
an automatic designing step of computing output value information in compliance with output value computing information containing computational expressions, based on input value information required for automatic design of a product;
a draughting information forming step of forming draughting information to display the input value information, the output value information, and a drawing showing a shape based on the input value information and the output value information;
an image displaying step of displaying a drawing based on the draughting information; and
an attribute changing step of changing a display attribute on a drawing displayed by the image displaying step such that a display mode of the input value information is made different distinguishably from display modes of other information.

5. An automatic design method, according to claim 4, wherein, when the output value information is changed, the attribute changing step changes the display attribute on the drawing displayed by the image displaying step such that a display mode of changed output value information is made different distinguishably from display modes of other output value information.

6. An automatic design method, according to claim 5, wherein the attribute changing step changes the display attribute such that a display mode of a shape of a portion that is changed following upon change of the output value information is made different distinguishably from display modes of shapes of other portions.

7. An automatic design program of causing a computer to execute
an automatic designing process of computing output value information in compliance with output value computing information containing computational expressions, based on input value information required for automatic design of a product,
a draughting information forming process of forming draughting information to display the input value information, the output value information, and a drawing showing a shape based on the input value information and the output value information,
an image displaying process of displaying a drawing based on the draughting information, and
an attribute changing process of changing a display attribute on a drawing displayed by the image displaying step such that a display mode of the input value information is made different distinguishably from display modes of other information.

8. An automatic design program according to claim 7, wherein, when the output value information is changed, the attribute changing process changes the display attribute on the drawing displayed by the image displaying process such that a display mode of changed output value information is made different distinguishably from display modes of other output value information.

9. An automatic design program according to claim 8, wherein the attribute changing process changes the display attribute such that a display mode of a shape of a portion that is changed following upon change of the output value information is made different distinguishably from display modes of shapes of other portions.
